(19) United States
(12) Patent Application Publication
(10) Pub. No.: US 2022/0274003 A1
(43) Pub. Date: Sep. 1, 2022

(54) PERFORMANCE EVALUATION APPARATUS, DATA ACQUISITION APPARATUS, METHODS THEREFOR AND PROGRAM

(71) Applicant: NIPPON TELEGRAPH AND TELEPHONE CORPORATION, Tokyo (JP)

(72) Inventors: Daiki NASU, Tokyo (JP); Toshitaka KIMURA, Tokyo (JP); Naoki SAIJO, Tokyo (JP); Makio KASHINO, Tokyo (JP)

(73) Assignee: NIPPON TELEGRAPH AND TELEPHONE CORPORATION, Tokyo (JP)

(21) Appl. No.: 17/638,782

(22) PCT Filed: Aug. 30, 2019
(86) PCT No.: PCT/JP2019/034173

§ 371 Date: Feb. 25, 2022

(51) Int. Cl. A63B 71/06; A63B 69/00

(52) U.S. Cl. CPC A63B 71/0622; A63B 69/0002; A63B 2069/0008; A63B 2102/18

(57) ABSTRACT

A performance evaluation device 160 is a performance evaluation device that evaluates a batting performance of a batter in a sport in which balls pitched at various velocities are visually assessed and batted and that includes a performance evaluation unit 169 that evaluates the batting performance of the batter, based on information relevant to movements of the balls obtained as a result of batting of the batter when the balls of a plurality of types of pitch are thrown at random without the batter befog informed of the types of pitch.

### TECHNICAL FIELD

The present invention relates to a technique for evaluating a batting performance of a batter in a sport such as softball or baseball in which balls pitched at various velocities are visually assessed and batted.

### BACKGROUND ART

When batting in softball or baseball, it is necessary to visually assess the type of pitch of a ball approaching with a high velocity in a short period of time, to determine what movement needs to be made, and to perform the ideal movement accurately. As methods of evaluating an athletic performance of a subject (a batter) in such a movement, methods described in Non-Patent Literature 1 and Non-Patent Literature 2 are known.

In Non-Patent Literature 1, a plurality of softball players were provided with a task of batting straight balls (fast balls) and changeup balls (slow balls) that were pitched at random without being informed of the types of pitch. As a result, it was observed that advanced-level players were able to delay the timing to start a bat swing according to the ball velocity (i.e., able to make a brief pause before the start of the swing for a changeup ball) more skillfully than medium-level players. Further, it was also observed that the timing to start a swing was relevant to accuracy in assessing the type of pitch, which was evaluated by another button pressing task.

In Non-Patent Literature 2, a plurality of baseball players were provided with a task of batting a ball sitting still on a table (tee placement batting). It was observed that advanced baseball players exhibited higher swing velocities and higher batted ball velocities than players at lower levels.

### CITATION LIST

### Non-Patent Literatures

Non-Patent Literature 1: Nasu, D., Yamaguchi, M., Fukuda, T., Saijo, N., Kashino, M. and Kimura, T., Perception-action linkage during batting in top athletes, Society for Neuroscience 47th Annual Meeting Conference, Washington, D. C., November 2017.

Non-Patent Literature 2: Inkster, B., Murphy, A., Bower, R., and Watsford, M. (2011), Differences in the kinematics of the baseball swing between hitters of varying skill, Medicine and Science in Sports and Exercise, 43(6), 1050-1054.

### SUMMARY OF THE INVENTION

### Technical Problem

The technique in Non-Patent Literature 1 merely observes the timing to start a swing, which reflects the capability of assessing the type of pitch. It is therefore not guaranteed whether the actual batting capability is correctly evaluated. For example, even when a batter is able to skillfully delay the timing to start a swing by accurately assessing the type of pitch, he/she would be unable to bat a ball back powerfully enough unless he/she has a swinging skill to accurately bat in accordance with the trajectory of the ball. Conversely, even when a batter has a skill to swing a bat to accurately meet the ball, he/she would be unable to bat a ball back powerfully enough unless he/she is able to make a powerful swing.

In contrast, the technique described in Non-Patent Literature 2 merely evaluates swinging skills that do not require determination of the types of pitch. It is therefore not guaranteed whether batting capabilities useful in actual games are correctly evaluated. For example, even when a batter is able to bat a still ball accurately and powerfully, he/she would be unable, in actual games that require determining the types of pitch, to bat a ball back powerfully enough like batting the still ball, unless he/she has a capability to assess the type of pitch accurately.

In view of the circumstances described above, it is an object of the present invention to correctly evaluate the batting performance of batters in a sport in which balls pitched at various velocities are visually assessed and batted.

### Means for Solving the Problem

A performance evaluation device according to an aspect of the present invention evaluates a batting performance of a batter in a sport in which balls pitched at various velocities are visually assessed and batted. The performance evaluation device includes: a performance evaluation unit that evaluates the batting performance of the batter, based on information relevant to movements of the balls obtained as a result of batting of the batter when the balls of a plurality of types of pitch are thrown at random without the batter being informed of the types of pitch.

A data acquisition device according to another aspect of the present invention acquires data used for evaluating a batting performance of a batter in a sport in which balls pitched at various velocities are visually assessed and batted. The data acquisition device includes: a data processing unit that acquires information relevant to movements of the balls obtained as a result of batting of the batter when the balls of a plurality of types of pitch are thrown at random without the batter being informed of the types of pitch.

### Effects of the invention

According to the present invention, it is possible to correctly evaluate the batting performance of the batter in a sport in which balls pitched at various velocities are visually assessed and batted.

### BRIEF DESCRIPTION OF DRAWINGS

FIG. 1 is a block diagram for showing an example cf a functional configuration of a performance evaluation device according to an embodiment.

FIG. 2 is a block diagram for showing an example cf a functional configuration of a data acquisition device according to the embodiment.

FIG. 3 is a block diagram for showing an example of a functional configuration of another data acquisition device according to the embodiment.

FIG. 4 is a drawing showing an example of a functional configuration or a computer.

### DESCRIPTION OF EMBODIMENTS

The present invention is related to a performance evaluation to evaluate a batting performance of a batter in a sport such as softball or baseball in which balls pitched at various velocities are visually assessed and batted. The following will describe embodiments of the present invention with reference to the drawings.

In the following sections, it is assumed that there are two types of pitch for the balls thrown by a pitcher, namely a ball that is faster such as a so-called “straight” ball and a ball that is slower such as a so-called “changeup” ball. In the following sections, the faster ball will be referred to as a “fast ball”, whereas the slower ball will be referred to as a “slow ball”. Also, in the following sections, the situation where balls of a plurality of types of pitch are thrown at random without the “batter” being informed of the types of pitch prior to the throws will be referred to as being under the “uninformed condition”.

[A First Example of the Batting Performance Evaluation]

As a first example, an example will be explained in which a batting performance of a batter is evaluated based on a “statistical batted ball velocity” and a “swing-and-miss ratio” of the batter acquired under the uninformed condition.

«Statistical BATTED BALL VELOCITY»

The “statistical batted ball velocity” denotes a prescribed statistical value regarding “batted ball velocities” of batted balls obtained with respect to each batter when a prescribed number of balls are thrown under the uninformed condition. The “batted ball velocity” of each ball batted by a batter under the uninformed condition may be obtained, for example, by using any of the methods described below. In the present example, the prescribed statistical value denotes an average value, for example. In other words, when the “statistical batted ball velocity” is expressed as Vexitₛ, whereas the “batted ball velocity” is expressed as Vexit, Vexitₛ is calculated as an average value of Vexit values of all the batted balls of each batter.

For example, it is possible to calculate the “batted ball velocity” from “batted ball movement data” obtained from each batted ball. The “batted ball movement data” is time-series data of a physical quantity expressing a movement of the batted ball occurring as a result of the batter batting a fast ball under the uninformed condition or batting a slow ball under the uninformed condition. Examples of the physical quantity expressing the movement include a position, a velocity, and the like. The “batted ball movement data” described herein includes information expressing movement timing of the batted ball. The “batted ball velocity” can be calculated from a velocity vector included in the “batted ball movement data”. The “batted ball velocity” may denote, for example, the magnitude of a velocity vector observed at a prescribed time that is later than the collision (the batting) between the bat and the pitched ball resulting from a swinging action of the batter or may denote, alternatively, an average value of magnitudes of velocity vectors measured over a certain time period after the prescribed time. Examples of the prescribed time include a time at which the time-series data of the velocities starts becoming stable immediately after the batting; and a time at which the batted ball passes a prescribed position (e.g., a position away from the home base by a prescribed distance). It is also possible to calculate the “batted ball velocity” from time-series data of positions included in the “batted ball movement data”. When calculation is made from the time-series data of the positions, for example, a batted ball velocity is calculated as Vexit=|p1−p2|/|t1−t2| by using times t1 and t2 at which the batted ball passed prescribed two points p1 and p2 of which the distances are known. In the present example, t1 denotes the time at which the batted ball passed the position p1, whereas t2 denotes the time at which the batted ball passed the position p2. As another method of obtaining the “batted ball velocity”, it is also possible to measure the batted ball velocity by using a speed gun or a commercially-available radar-based ball trajectory measurement tool such as those from Trackman (registered trademark).

As for the “batted balls when the prescribed number of balls are thrown under the uninformed condition” mentioned above, it is a good idea to use batted balls that flew to a fair zone, among the balls being batted when the prescribed number of balls were thrown under the uninformed condition. In other words, it is a good idea to calculate the “statistical batted ball velocity” from the batted balls that flew to the fair zone, and not to foul zones. That is to say, it is possible to calculate the “statistical batted ball velocity”, by calculating the prescribed statistical value with respect to the “batted ball velocities” of the batted balls determined to have flown to the fair zone. In this regard, it is possible to determine whether or not each batted ball flew to the fair zone, through an image recognition using a camera picture of the batted ball.

«Swing-and-Miss Ratio»

The swing-and-miss ratio is calculated as a ratio (Rmiss) of the number of swings-and-misses (Nmiss) to the number of bat swings (Nswing) when the prescribed number of balls are thrown under the uninformed condition. In other words, it is possible to use the expression: Rmiss=Nmiss/Nswing.

It is possible to determine whether or not the bat was swung by determining whether or not at least one of, or an integrated value of, or an average value of, pieces of time-series data of velocities of the hands of the batter or of the bat held by the batter acquired over a certain time period after the throw of the ball exceeds a prescribed threshold value. Alternatively, whether or not the bat was swung may be visually determined.

It is possible to determine whether or not a swing-and-a-miss occurred by using an output of a sensor that captures the movement of the ball, regarding whether or not the trajectory of the ball changed when the batter swung the bat. If the trajectory of the ball changed when the batter swung the bat, it as possible to determine that the batter did not have a swing-and-a-miss. Conversely, if the trajectory of the ball did not change when the batter swung the bat, it is possible to determine that the batter had a swing-and-a-miss. Alternatively, it is also acceptable to determine whether or not a swing-and-a-miss occurred through an image recognition using a camera picture.

It should be noted that the swing-and-miss ratio is not calculated from all of the prescribed number of balls. Among the prescribed number of balls, the balls which the batter let pass without swinging are eliminated, so that the calculation is made from the balls at which the batter swung.

The number of pieces of data each indicating whether or not a batter had a swing-and-a-miss is equal to the number of bat swings (Nswing) of the batter. Among all the pieces of data each indicating whether or not the batter had a swing-and-a-miss, the number of pieces of data each indicating that the batter had a swing-and-a-miss serves as the number of swings-and-misses (Nmiss).

Accordingly, from the data indicating whether or not each batter had swings-and-misses, it is possible to calculate the swing-and-miss ratio of the batter.

«Evaluation of Batting Performances»

The utmost goal of the batting in a sport such as softball or baseball is to hit a homerun or to get a hit. To hit a homerun, one of important elements is to extend the flight distance of a batted ball so as to reach an outfield stand. It is therefore important to increase the batted ball velocity. Further, to get a hit without being caught by an opponent's fielder, one of important elements is to make the batted ball pass between fielders. It is therefore important, again, to increase the batted ball velocity. Furthermore, if a bat of a batter cannot meet a ball, there will be no batted ball, which means there will be no homerun or hit. Having a higher strike count increases the possibility of getting an out. It is therefore important to also reduce the number of swings-and-misses.

However, even if a batter is able to bat a still ball with a high batted ball velocity, unless he/she has a high capability of assessing the type of pitch, he/she would be unable, in actual games, to bat with a high batted ball velocity like with the still ball. Also, even if a batter has few swings-and-misses when being informed of the type of pitch (e.g., whether the ball is a fast ball or a slow ball), unless he/she has a high capability of assessing the type of pitch, he/she would be unable, in actual games, to keep the number of swings-and-misses down like when he/she is informed of the types of pitch. Accordingly, if the swing-and-miss ratio were calculated with a statistical batted ball velocity using still balls or with the batter being informed of the types of pitch, it would not be possible to sufficiently explain a batting performance of the batter in actual games, i.e., the batting performances of the batter in a sport in which balls pitched at various velocities are visually assessed and batted.

To cope with the circumstances described above, in the first example, to evaluate a batting performance of a batter in actual games, i.e., the batting performance of the batter in a sport in which balls pitched at various velocities are visually assessed and batted, the evaluation of the batting performance of the batter is made by using the “statistical batted ball velocity” acquired under the uninformed condition and the “swing-and-miss ratio” acquired under the uninformed condition. A batter exhibiting a higher statistical batted ball velocity acquired under the uninformed condition is evaluated as having a higher batting performance. Conversely, a batter exhibiting a lower statistical batted ball velocity acquired under the uninformed condition is evaluated as having a lower batting performance. Further, a batter exhibiting a lower swing-and-miss ratio acquired under the uninformed condition is evaluated as having a higher batting performance. Conversely, a batter exhibiting a higher swing-and-miss ratio acquired under the uninformed condition is evaluated as having a lower batting performance. In this situation, these elements may individually be evaluated. Alternatively, the evaluation may be made by using a multiple regression analysis while including both of the variables. For example, when P denotes a batting performance of a batter, it is possible to express P by using the statistical batted ball velocity Vexitₛ acquired under the uninformed condition and the swing-and-miss ratio Rmiss acquired under the uninformed condition as shown below:

P=a+bVexitₛ+cRmiss (1)

where “a” denotes the intercept, whereas “b” and “c” are each a partial regression coefficient. The letters a, b, and c are each a constant that is determined as appropriate so as to achieve a desirable result. In this situation, by calculating a coefficient of determination R² expressing the level of precision or the regression, it is possible to clarify how much the “statistical batted ball velocity” and the “swing-and-miss ratio” that are acquired when the prescribed number of balls are thrown under the uninformed condition are able to account for a batting performance.

With respect to each of the seventeen softball players in an adult amateur team, the inventor acquired time-series data of batted ball velocities observed at the time of batting fast balls and slow balls pitched under the uninformed condition, calculated an average value of magnitudes of the velocity vectors at five data points immediately after the batting of each batted ball, and subsequently calculated an average value of all the batted balls of each player as the “statistical batted ball velocity. Further, with respect to each of the seventeen players, the inventor visually determined the number of swings and the number of swings-and-misses during the batting, so as to calculate the “swing-and-miss ratio”. As a result, it was observed that she “statistical batted ball velocities” acquired under the uninformed condition and the “swing-and-miss ratios” acquired under the uninformed condition with respect to the seventeen players are able to account for 67% (R²=0.664) of the season batted averages of these players in the same year as the year of the data acquisition. The season batted average is calculated as “the number of hits/at bat” for each player during the games in one year including official games and practice games. The results indicate that an important element for increasing a player's batted average in the actual games depends on whether or not the player is able to increase the statistical batted ball velocity under the uninformed condition and to decrease the swing-and-miss ratio under the uninformed condition. In contrast, the timing to start a swing, which reflects the capability to assess the type of pitch, as described in Non-Patent Literature 1, was able to account for only 34% (R²=0.340) of the season batted averages. Further, the swing velocities against still balls such as those described in Non-Patent Literature 2 were not able to offer any significant accountability percentage (R²=−0.07). These results indicate that, when evaluating the batting capabilities of batters in actual games, it is insufficient to simply evaluate the capability to assess the types of pitch separately from the swinging capability that does not involve the assessment of the types of pitch. It means that it is important to make an evaluation including both the capability to assess the types of pitch and the swinging capability, i.e., to evaluate the statistical batted ball velocity and the swing-and-miss ratio, which are output results obtained at the time of batting fast balls and slow balls pitched under the uninformed condition.

[A Second Example of the Batting Performance Evaluation]

As a second example, an example will be explained in which a batting performance of a batter is evaluated based on a “statistical batted ball angle” of the batter acquired under the uninformed condition, in addition to the “statistical batted ball velocity” and the “swing-and-miss ratio” of the batter acquired under the uninformed condition described in the first example.

«Statistical Batted Ball Angle»

The “statistical batted ball angle” denotes a prescribed statistical value regarding “batted ball angles” of all the batted balls with respect to each batter. The “batted ball angle” of each ball batted by a batter under the uninformed condition may be obtained, for example, by using any of the methods described below. In the present example, the prescribed statistical value denotes an average value, for example.

Similarly to the “hatted ball velocity”, it is possible to calculate the “batted ball angle” from the “batted ball movement data” acquired with respect to each batted ball, for example. The calculation may be made from the velocity vectors included in the “batted ball movement data”. The batted ball angle may be, for example, the direction of a velocity vector immediately after the batting and may be, alternatively, an average value of the directions of velocity vectors measured over a certain time period since the batting. As another method of obtaining the “batted ball angle”, it is also possible to measure the batted ball angle by using a commercially-available radar-based ball trajectory measurement tool such as those from Trackman (registered trademark).

As for the “batted balls when the prescribed number of balls are thrown under the uninformed condition” mentioned above, it is a good idea to use batted balls that flew to a fair zone, among the balls being batted when the prescribed number of balls were thrown under the uninformed condition. In other words, it is a good idea to calculate the “statistical batted ball angle” from the batted balls that flew to the fair zone, and not to foul zones. That is to say, it is possible to calculate the “statistical batted ball angle”, by calculating the prescribed statistical value with respect to the “batted ball angles” of the batted balls determined to have flown to the fair zone. In this regard, it is possible to determine whether or not each batted ball flew to the fair zone, through an image recognition using a camera picture of the batted ball.

«Evaluation of Batting Performances»

Similarly to the “statistical batted ball velocity” and the “swing-and-miss ratio”, the “statistical batted ball angle” is also important for the batting in a sport such as softball or baseball. Accordingly, in the second example, to evaluate a batting performance of a batter in actual games, i.e., the batting performance of the batter in a sport in which balls pitched at various velocities are visually assessed and batted, the evaluation of the batting performance of the batter is made by using the “statistical batted ball velocity” acquired under the uninformed condition, the “statistical batted ball angle” acquired under the uninformed condition, and the “swing-and-miss ratio” acquired under the uninformed condition.

For example, while the angle of a batted ball with respect to the ground is used as the “statistical batted ball angle”, a batter whose “statistical batted ball angle” acquired under the uninformed condition is closer to an optimal angle set in advance is evaluated as having a higher batting performance. Conversely, a batter whose “statistical batted ball angle” acquired under the uninformed condition is farther from the optimal angle is evaluated as having a lower batting performance. The evaluations using the “statistical batted ball velocity” and the “swing-and-miss ratio” are the same as those in the first example. Further, similarly to the first example, it is also acceptable to make an evaluation by using a multiple regression analysis while including three variables expressing the “statistical batted ball velocity” acquired under the uninformed condition, the “statistical batted ball angle” acquired under the uninformed condition, and the “swing-and-miss ratio” acquired under the uninformed condition.

The optimal angle is, for example, approximately 28 degrees with respect to the ground. It is known that the optimal angle may slightly increase or decrease in relation to batted ball velocities. For example, when a batted ball velocity is 98 m/h, the optimal angle is in the range of 26 degrees to 30 degrees. When a batted ball velocity is 99 m/h, the optimal angle is in the range of 25 degrees to 31 degrees. For this reason, the optimal angle may be set in advance, for example, as an angle that falls in the range of 26 degrees to 30 degrees or the range of 25 degrees to 31 degrees.

[An Evaluation of the Batting Performances in the Present Embodiment]

The “statistical batted ball velocity” and the “statistical batted ball angle” acquired under the uninformed condition described above are indices regarding the movements of the balls obtained as a result of the batting of the batter, based on both the assessment of the type of pitch, which is a recognition element of the batter against the pitched ball, and the swinging action, which is an athletic element of the batter based on the recognition. Further, based on the notion that a batted ball occurs when the batter does not have a swing-and-a-miss and that no batted ball occurs when the batter has a swing-and-a-miss, the “swing-and-miss ratio” acquired under the uninformed condition described above is also an index regarding the movements of the balls obtained as a result of the batting of the batter, based on both the assessment of the type of pitch, which is a recognition element of the batter against the pitched ball, and the swinging action, which is an athletic element of the batter based on the recognition. In other words, in the present embodiment, a batting capability of a batter in actual games, i.e., the batting performance of the batter in a sport in which balls pitched at various velocities are visually assessed and batted, is evaluated based on the information relevant to the movements of the balls and the indices regarding the movements obtained as a result of the batting of the batter acquired under the uninformed condition.

### First Embodiment

The following will describe a performance evaluation device and a method for evaluating a batting performance of a batter in a sport in which balls pitched at various velocities are visually assessed and batted, mentioned above.

«Performance Evaluation Device 160»

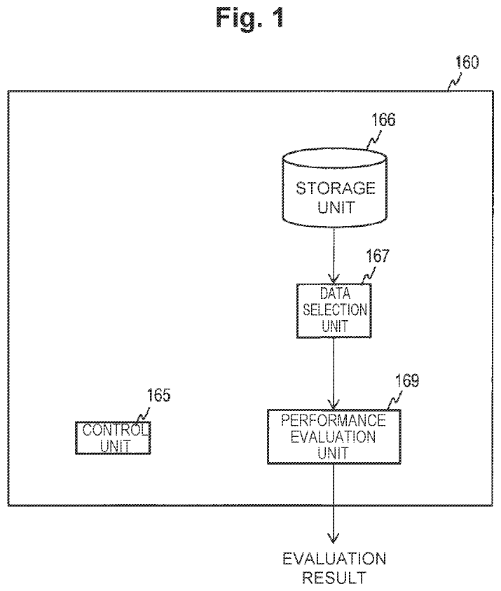

As shown in FIG. 1, a performance evaluation device 160 includes: a storage unit 166, a data selection unit 167, a performance evaluation unit 169, and a control unit 165.

<Performance Evaluation Process>

A performance evaluation process performed by the performance evaluation device 160 is a process to evaluate a batting performance of a batter based on, as described above, the movements of the balls and the indices regarding the movements obtained as a result of the batting of the batter acquired under the uninformed condition. The performance evaluation device 160 performs the following processes under control of the control unit 165.

«Storage of Data (Step S166)»

The storage unit 166 included in the performance evaluation device 160 (FIG. 1) stores therein, among others, batted ball movement data of each of the batted balls of each of the batters and data indicating whether or not each batter had one or more swings-and-misses.

«Data Selection Process (Step S167)»

From within the storage unit 166, as data with which a batting performance is to be evaluated, the data selection unit 167 selects from the batted ball movement data of each of the batted balls of each of the batters and the data indicating whether or not each batter had one or more swings-and-misses and further outputs the selected data to the performance evaluation unit 169.

«Performance Evaluation Process (Step S169)»

The performance evaluation unit 169 receives an input of the batted ball movement data of each of the batted balls of each of the batters and the data indicating whether or not each batter had one or more swings-and-misses which were selected by the data selection unit 167 and with which the batting performance is to be evaluated.

The performance evaluation unit 169 obtains an evaluation result of the batting performance of each of the batters, based on the input data.

The following will describe an example of an operation performed by the performance evaluation unit 169, while the batter whose batting performance is evaluated is expressed as “i”. The performance evaluation unit 169 performs the following processes on each of the batters whose batting performance is evaluated.

At first, the performance evaluation unit 169 calculates information relevant to movements of balls obtained from the batting of the batter i, based on the batted ball movement data of each of the batted balls of the batter i and the data indicating whether or not the batter i had one or more swings-and-misses.

In this situation, the “information relevant to the movements of the balls” obtained from the batting of the batter denotes the information related to the movements of the balls obtained from the batting of the specific batter, such as the “statistical batted ball velocity” obtained from the batting of the specific batter, the “swing-and-miss ratio” of the specific batter, and the “statistical batted ball angle” obtained from the batting of the specific batter.

The “information relevant to the movements of the balls” is, in other words, an “index of the movements of the balls” or an “index regarding the movements of the balls”.

For example, the “information relevant to the movements of the balls” obtained from the batting of a batter denotes at least the “statistical batted ball velocity” obtained from the batting of the specific batter and the “swing-and-miss ratio” of the specific batter.

In this situation, based on the information relevant to the movements of the balls obtained as a result of the batting of the batter i, the performance evaluation unit 169 evaluates the batting performance of the batter i in such a manner that the evaluation is higher when the statistical batted ball velocity is higher and that the evaluation is higher when the swing-and-miss ratio is lower.

In this situation, based on the information relevant to the movements of the balls obtained from the batting of the batter i, the performance evaluation unit 169 may calculate an evaluation value expressing the batting performance of the batter i in such a manner that the evaluation value is larger when the statistical batted ball velocity is higher and that the evaluation value is larger when the swing-and-miss ratio is lower. It is possible to calculate the evaluation value by using Expression (1), for example.

Further, for example, the “information relevant to the movements of the balls” obtained from the batting of a batter denotes at least one of the “statistical batted ball velocity” obtained from the batting of the specific batter, the “swing-and-miss ratio” of the specific batter, and the “statistical batted ball angle” obtained from the batting of the specific batter.

In this situation, based on at least one of the statistical batted ball velocity, the swing-and-miss ratio, and the statistical batted ball angle obtained from the batting of the batter i, the performance evaluation unit 169 evaluates the batting performance of the batter i in such a manner that the evaluation is higher when the statistical batted ball velocity is higher, that the evaluation is higher when the swing-and-miss ratio is lower, and that the evaluation is higher when the statistical batted ball angle is closer to the predetermined optimal angle.

In this situation, based on at least one of the statistical batted ball velocity, the swing-and-miss ratio, and the statistical batted ball angle obtained from the batting of the batter i, the performance evaluation unit 169 may calculate an evaluation value expressing the batting performance of the batter i in such a manner that the evaluation value is larger when the statistical batted ball velocity is higher, that the evaluation value is larger when the swing-and-miss ratio is lower, and that the evaluation value is larger when the statistical batted ball angle is closer to the predetermined optimal angle.

In these situations, by using the methods explained under the headings of «Statistical batted ball velocity», «Swing-and-miss ratio», and «Statistical batted ball velocity», the performance evaluation unit 169 is able to calculate the “statistical batted ball velocity”, the “swing-and-miss ratio”, and the “statistical batted ball angle” based on the batted ball movement data of each of the batted balls of each of the batters and the data indicating whether or not each batter had one or more swings-and-misses.

In the manner described above, the performance evaluation unit 169 evaluates the batting performance of each batter, based on the information relevant to the movements of the balls obtained as a result of the batting of the batter when the balls of the plurality of types of pitch are thrown at random without the batter being informed of the types of pitch.

### Second Embodiment

The following will describe a data acquisition device and a method for acquiring information relevant to movements of balls obtained as a result of batting of a batter, for the purpose of evaluating the batting performance of the batter in a sport such as softball or baseball, i.e., the batting performance of the batter in a sport in which the balls pitched at various velocities are visually assessed and batted.

<Configuration>

«Data Acquisition Device 110»

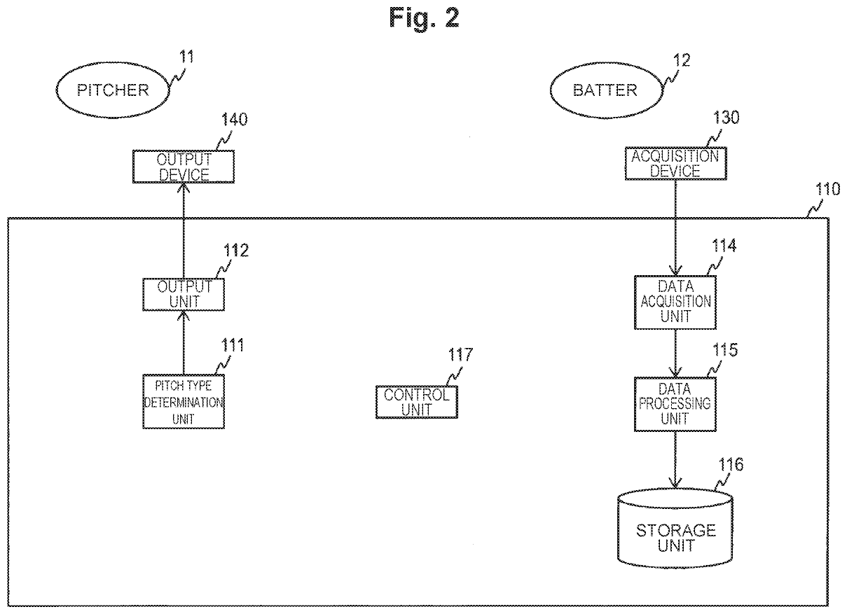

As shown in FIG. 2, a data acquisition device 110 in the present embodiment includes: a pitch type determination unit 111, an output unit 112, a data acquisition unit 114, a data processing unit 115, a storage unit 116, and a control unit 117. The data acquisition unit 114 is connected to an acquisition device 130, whereas the output unit 112 is connected to an output device 140.

«Acquisition Device 130»

The acquisition device 130 is a device for acquiring a movement of a ball and a movement of a batter 12.

The acquisition device 130 includes: a first sensor serving as a sensor for acquiring the movement of the ball; and a second sensor serving as a sensor for acquiring the movement of the batter 12. The same sensor may be used for both the first sensor and the second sensor.

As the first sensor, an existing device such as a camera or a laser measurement tool nay be used.

Examples of the second sensor include a sensor (e.g., an acceleration sensor, a velocity sensor, a gyro sensor, or a magnetic sensor) that is attached to a part of the body (e.g., the hip, the body trunk, an arm, a hand, or a shoulder) of the batter 12 or to the bat (e.g., the head or the grip of the bat) and that detects a physical quantity (e.g., a position, acceleration, angular acceleration, a velocity, an angular velocity, or a tangential velocity) expressing a movement (e.g., the magnitude or the velocity of a turning movement) of the part of the body of the batter 12 or the bat. Other examples of the acquisition device 130 include a camera that acquires a picture for acquiring position information of a part of the body of the batter 12 or a bat (e.g., the position of a reflective marker or the like attached to the part of the body of the batter 12 or to a bat) through motion capturing or the like. Alternatively, a high-speed camera may be used as the second sensor. Further, as the second sensor, it is also acceptable to use a camera or a sensor for acquiring position information of a part of the body of the batter 12 by using existing technology such as Kinect.

The information about the movement of the ball and the information about the movement of the batter 12 obtained by the acquisition device 130 are sent to the data acquisition unit 114.

«Output Device 140»

The output device 140 is a device that gives instructions to a pitcher 11. For example, the output device 140 gives an instruction to the pitcher 11 about a type of pitch (e.g., a straight ball (a fast ball) or a changeup ball (a slow ball)) to be thrown next. The output device 140 may be a display device or the like that displays information via text or a picture, may be a wireless earphone or the like that outputs information via audio, or may be a device that outputs information via stimulation such as vibration.

<Data Acquisition Process>

Next, a data acquisition process will be explained. In the data acquisition process, for the purpose of evaluating a batting performance of the batter 12, the data acquisition device 110 acquires information relevant to movements of balls obtained as a result of batting of the batter 12 under the uninformed condition. The data acquisition device 110 (FIG. 2) acquires the information relevant to the movements of the balls obtained as a result of the batting carried out in real environment (in response to the pitched balls actually thrown by the pitcher). Under control of the control unit 117, the data acquisition device 110 performs the following processes.

«Determination of Type of Pitch (Step S111)»

The pitch type determination unit 111 generates information indicating a type of pitch (e.g., a straight ball (a fast ball) or a changeup ball (a slow ball)) to be thrown next and outputs the generated information indicating the type of pitch. The information indicating the type of pitch is sent to the output unit 112. For example, the pitch type determination unit 111 may determine, in advance, the order in which different types of pitch are to be thrown by using random numbers or the like so that the two types of pitch, namely fast balls and slow balls, are randomly thrown among a plurality of pitched balls, so as to generate the information indicating the type of pitch to be thrown next according to the order of the pitches determined in advance.

«Output Process (Step S112)»

According to the sent information indicating the type of pitch, the output unit 112 sends information used for giving the pitcher 11 an instruction, to the output device 140. The output device 140 presents the pitcher 11 with the sent information. For example, when information indicating a fast ball is sent thereto, the output unit 112 sends information indicating that the next pitch is a fast ball, to the output device 140. In that situation, the output device 140 instructs the pitcher 11 to throw a fast ball next. Conversely, when information indicating a slow ball is sent thereto, the output unit 112 sends information indicating that the next pitch is a slow ball, to the output device 140. In that situation, the output device 140 instructs the pitcher 11 to throw a slow ball next.

«Pitching (Step S113)»

The pitcher 11 throws a ball of the type of pitch (a fast ball or a slow ball) according to the instruction presented by the output device 140.

«Data Acquisition Process (Step S114)»

The batter 12 carries out batting on the ball thrown by the pitcher 11 in step S113. The acquisition device 130 acquires information about the movement of the ball and information about the movement of the batter 12 involved in the batting. The information about the movement of the ball and the information about the movement of the batter 12 that have been acquired are sent to the data acquisition unit 114.

From the information about the movement of the ball and the information about the movement of the batter 12 acquired by the acquisition device 130, the data acquisition unit 114 acquires batted ball movement data of each of the batted balls of the batter 12 and data regarding whether or riot the batter 12 had one or more swings-and-misses and further sends the acquired pieces of data to the data processing unit 115.

«Data Processing Process (Step S115)»

The data processing unit 115 receives an input of the batted ball movement data of each of the batted balls of the batter 12 and the data regarding whether or not the batter 12 had one or more swings-and-misses that were sent in step S114.

Based on the batted ball movement data of each of the batted balls of the batter 12 and the data regarding whether or not the batter 12 had one or more swings-and-misses, the data processing unit 115 calculates information relevant to the movements of the balls obtained from the batting of the batter 12.

The definition and the calculation method of the “information relevant to the movements of the balls” are the same as those explained in the first embodiment.

For example, the “information relevant to the movements of the balls” obtained from the batting of a batter denotes at as the “statistical batted ball velocity” obtained from the batting of the specific batter and the “swing-and-miss ratio” of the specific batter.

In this situation, the data processing unit 115 acquires at least the statistical batted ball velocity and the swing-and-miss ratio from the batting of the batter 12 when balls of the plurality of types of pitch are thrown at random without the batter 12 being informed of the types of pitch.

In another example, the “information relevant to the movements of the balls” obtained from the batting of a batter may denote at least one of the “statistical batted ball velocity” obtained from the batting of the specific batter, the “swing-and-miss ratio” of the specific batter, and the “statistical batted ball angle” obtained from the batting of the specific batter.

In this situation, the data processing unit 115 acquires at least one of the statistical batted ball velocity, the swing-and-miss ratio, and the statistical batted ball angle from the batting of the batter 12 when balls of the plurality of types of pitch are thrown at random without the batter 12 being informed of the types of pitch.

In the manner described above, the data processing unit 115 acquires the information relevant to the movements of the balls obtained as a result of the batting of the batter 12 when the balls of the plurality of types of pitch were thrown at random without the batter 12 being informed of the types of pitch.

The information relevant to the movements of the balls acquired by the data processing unit 115 is stored into the storage unit 116.

### Third Embodiment

Next, a third embodiment will be explained. The present embodiment is a modification example of the second embodiment, and a pitching device (a pitching machine) in place of the pitcher 11 throws balls. The following will primarily explain differences from the second embodiment. As for some parts that are the same as those in the second embodiment, the duplicate explanations thereof will be omitted.

<Configuration>

«Data Acquisition Device 310

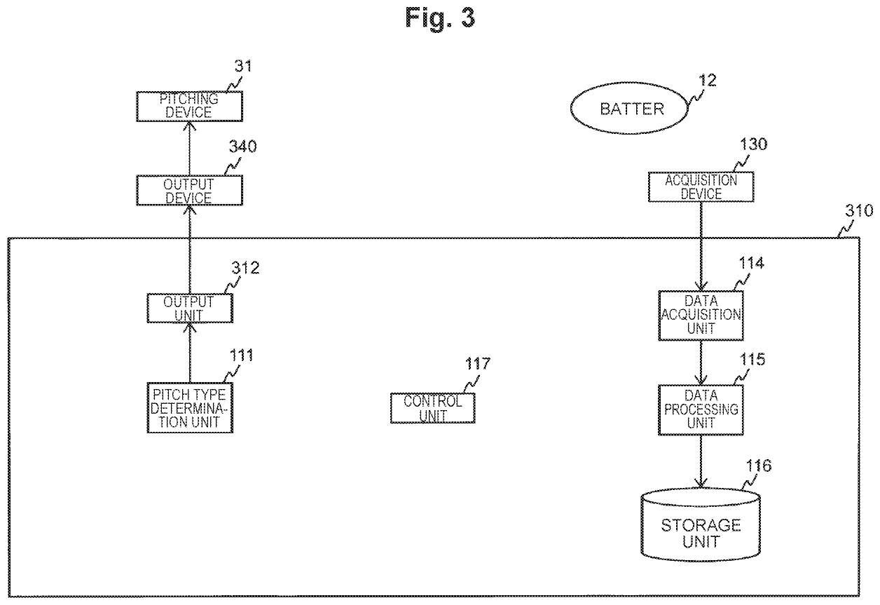

As shown in FIG. 3, a data acquisition device 310 according to the present embodiment includes: the pitch type determination unit 111, an output unit 312, the data acquisition unit 114, the data processing unit 115, the storage unit 116, and the control unit 117. The data acquisition unit 114 is connected to the acquisition device 130. The output unit 312 is connected to an output device 340. The output device 340 is connected to a pitching device 31.

«Output Device 340»

The output device 340 is a device that gives instructions to the pitching device 31. For example, the output device 340 gives an instruction to the pitching device 31 about a type of pitch (e.g., a straight ball (a fast ball) or a changeup ball (a slow ball)) to be thrown next.

«Pitching Device 31»

The pitching device 31 is a device that throws a ball of the type of pitch according to the instruction from the output device 340.

<Data Acquisition Process>

In a data acquisition process according to the present embodiment, the pitching device 31 in place of the pitcher 11 throws balls.

«Determination of Type of Pitch (Step S111)»

This process is the same as that in the second embodiment.

«Output Process (Step S312)»

In the present embodiment, step S312 is performed in place of step S112. In step S312, according to the sent information indicating the type of pitch, the output unit 312 sends information used for giving the pitching device 31 an instruction about the type of pitch, to the output device 340. The output device 340 sends the sent information to the pitching device 31. For example, when information indicating a fast ball is sent thereto, the output unit 312 sends information indicating that the next pitch is a fast ball, to the output device 340. In that situation, the output device 340 instructs the pitching device 31 to throw a fast ball next. Conversely, when information indicating a slow ball is sent thereto, the output unit 312 sends information indicating that the next pitch is a slow ball, to the output device 340. In that situation, the output device 340 instructs the pitching device 31 to throw a slow ball next.

«Pitching Process (Step S313)»

In the present embodiment, step S313 is performed in place of step S113. In step S313, the pitching device 31 throws a ball of the type of pitch (a fast ball or a slow ball) according to the instruction from the output device 340.

«Data Acquisition Process (Step S114)»

This process is the same as the process in the second embodiment, except that the batter 12 carries out the batting on the balls pitched by the pitching device 31 in place of the pitcher 11.

«Data Processing Process (Step S115)»

This process is the same as the process in the second embodiment.

The data acquisition device 310 repeatedly performs, multiple times, the processes in step S111, S312, S313, S114, and S115 under the control of the control unit 117. In the manner described herein, the data acquisition device 310 acquires the information relevant to the movements of the balls regarding the batter 12 and stores the acquired information into the storage unit 116.

### OTHER MODIFICATION EXAMPLES

The present invention is not limited to the embodiments described above. For example, in the embodiments described above, the data acquisition device and the performance evaluation device are devices separate from each other; however, the data acquisition device and the performance evaluation device may be integrally formed. Alternatively, a part of the processes of the data acquisition device described above may be performed by the performance evaluation device. Conversely, a part of the processes of the performance evaluation device described above may be performed by the data acquisition device. In the embodiments described above, the information relevant to the movements of the balls stores a table into the storage unit 116; however, another arrangement is also acceptable in which information obtained from the information relevant to the movements of the balls is stored into the storage unit 116. In that situation, the data selection unit 167 selects information relevant to the movements of the balls with respect to each of the batters from the storage unit 116 and further outputs the selected information to the performance evaluation unit 169, so that the performance evaluation unit 169 obtains an evaluation result of the batting performance of each of the batters, from the information relevant to the movements of the balls with respect to the batter that has been input.

Further, in the embodiments described above, the example was explained in which the average value is used as the prescribed statistical value; however, it is also acceptable to use a statistical value other than the average value, such as a median value, a maximum value, a variance, or a standard deviation. When a median value of the batted ball velocities is used, for example, even when the batted balls derived from the prescribed number of pitched balls include an extremely fast batted ball such as a so-called “fluke”, it is possible to evaluate the batting performance while suppressing the impact of the batted ball velocity of the “fluke”. More specifically, when the median value of the batted ball velocities is used as the statistical batted ball velocity, the batting performance shall be evaluated in such a manner that the evaluation is higher when the statistical batted ball velocity calculated as the median value of the batted ball velocities is higher. In another example, by using a maximum value of the batted ball velocities, it is possible to evaluate a batting performance such as the number of homeruns or a slugging percentage. More specifically, when the maximum value of the batted ball velocities as used as the statistical batted ball velocity, the batting performance shall be evaluated in such a manner that the evaluation is higher when the statistical batted ball velocity calculated as the maximum value of the batted ball velocities is higher. In yet another example, by using a variance or a standard deviation of the batted ball velocities, it is possible to evaluate the batting performance from a viewpoint as to whether the batter is able to stably bat well against a pitcher (a so-called “easy pitcher”) who makes an average value of batted ball velocities of many batters large. More specifically, when the variance or the standard deviation of the batted ball velocities is used as the statistical batted ball velocity, the batting performance shall be evaluated in such a manner that the evaluation is higher when the statistical batted ball velocity calculated as the variance or the standard deviation of the batted ball velocities is lower. In yet another example, by using a median value of the batted ball angles, for example, even when the batted balls derived from the prescribed number of pitched balls include a batted ball that happens to have a batted ball angle very far from the optimal angle by mistake, it is possible to evaluate the batting performance while suppressing the impact of the batted ball angle of the batted ball that happened to be a mistake. More specifically, when the median value of the batted ball angles is used as the statistical batted ball angle, the batting performance shall be evaluated in such a manner that the evaluation is higher when the statistical batted ball angle calculated as the median value of the batted ball angles is closer to the predetermined optimal angle.

The various types of processes described above do not necessarily have to be performed in a time series as described and may be performed in parallel or individually in accordance with processing capabilities of the devices that perform the processes or as necessary. Furthermore, needless to say, modifications may be made as appropriate without departing from the scope of the present invention.

The data acquisition device and the performance evaluation device described above are, for example, structured as a result of a prescribed program being executed by a generic or dedicated computer including a processor (a hardware processor) such as a Central Processing Unit (CPU) and memory elements such as a Random-Access Memory (RAM) and/or a Read-Only Memory (ROM). The computer may include a single processor and a single memory element or may include multiple processors and memory elements. The program may be installed in a computer or may be recorded in a ROM or the like in advance. Further, a part or all of the processing units may be structured by using electronic circuitry capable of realizing processing functions without using a program, instead of using electronic circuitry, such as a CPU, that realizes a functional configuration as a result of reading the program. Electronic circuitry structuring a single device may include two or more CPUs.

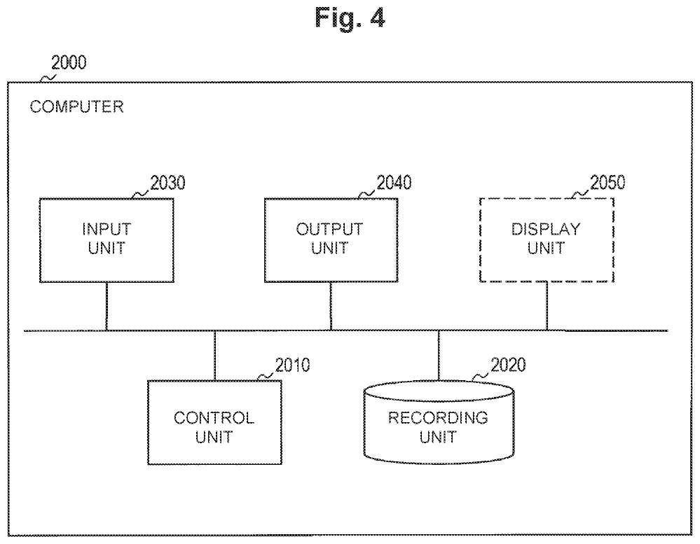

When the configuration described above is realized by using a computer, the content of the processes of the functions included in the devices is described in a program. As a result of causing a computer to execute the program, the processing functions mentioned above are realized by the computer. For example, it is possible to carry out the various types of processes described above, by causing a recording unit 2020 of the computer shown in FIG. 4 to read the program to be executed, so as to bring a control unit 2010, an input unit 2030, an output unit 2040, and the like into operation. The program describing the content of the processes may be recorded on a computer-readable recording medium. The computer-readable recording medium may be, for example, a non-transitory recording medium. Examples of this type of recording media include a magnetic recording device, an optical disk, magneto-optical recording medium, and a semiconductor memory.

The program may be distributed, for example, by selling, transferring, or lending a portable recording medium such as a DVD or a CD-ROM having the program recorded thereon. Further, it is also acceptable to have the program distributed by storing the program in a storage device of a server computer, so that the program is transferred via a network from the server computer to another computer.

The computer that executes the program, for example, may at first temporarily store, into a storage device thereof, the program recorded on the portable recording medium or the program transferred from the server computer. At the time of executing the processes, the computer reads the program stored in the storage device thereof and executes the processes according to the read program. In another execution mode of the program, the computer may directly read the program from the portable recording medium so as to execute the processes according to the program. Furthermore, every time the program is transferred from the server computer to the computer, the computer may sequentially execute the processes according to the received program. Alternatively, it is also acceptable to execute the processes described above by using a so-called Application Service Provider (ASP) service where, without transferring the program from the server computer to the computer, the processing functions are realized only by instructing the execution and obtaining the results.

Instead of realizing the processing functions of the devices of the present disclosure by causing a computer to execute the prescribed program, it is also acceptable to realize at least a part of the processing functions by using hardware.

1. A performance evaluation device including circuitry that execute a method comprising: that
evaluating a batting performance of a batter in a sport in which balls pitched at various velocities are visually assessed and batted, and
wherein the evaluating is based at least on information relevant to movements of the balls obtained as a result of batting of the batter when the balls of a plurality of types of pitch are thrown at random without the batter being informed of a type of pitch.

2. The performance evaluation device according to claim 1, the circuitry further executes a method comprising:
evaluating the batting performance of the batter, based on at least a statistical batted ball velocity and a swing-and-miss ratio obtained from the batting of the batter when the balls of the plurality of types of pitch are thrown at random without the batter being informed of the plurality of types of pitch.

3. The performance evaluation device according to claim 2,
wherein the statistical batted ball velocity includes at least one of an average value, a median value, and a maximum value of batted ball velocities obtained from the batting of the batter when the balls of the plurality of types of pitch are thrown at random without the batter being informed of the plurality of types of pitch, and
the circuitry further executes a method comprising:
evaluating the batting performance of the batter in such a manner that the batting performance is higher when the statistical batted ball velocity is higher and that the batting performance is higher when the swing-and-miss ratio is lower.

4. The performance evaluation device according to claim 2, wherein
the statistical batted ball velocity includes at least one of a variance and a standard deviation of batted ball velocities obtained from the batting of the batter when the balls of the plurality of types of pitch are thrown at random without the batter being informed of the plurality of types of pitch, and
the circuitry further executes a method comprising:
evaluating the batting performance of the batter in such a manner that the batting performance is higher when the statistical batted ball velocity is lower and that the batting performance is higher when the swing-and-miss ratio is lower.

5. The performance evaluation device according to claim 1, the circuitry further executes a method comprising:
evaluating the batting performance of the batter, based on at least one of a statistical batted ball velocity, a swing-and-miss ratio, and a statistical batted ball angle obtained from the batting of the batter when the balls of the plurality of types of pitch are thrown at random without the batter being informed of the plurality of types of pitch.

6. The performance evaluation device according to claim 5,
wherein the statistical batted ball velocity includes at least one of an average value, a median value, and a maximum value of batted ball velocities obtained from the batting of the batter when the balls of the plurality of types of pitch are thrown at random without the batter being informed of the plurality of types of pitch,
wherein the statistical batted ball angle includes at least is one of the average value and a median value of batted ball angles obtained from the batting of the batter when the balls of the plurality of types of pitch are thrown at random without the batter being informed of the plurality of types of pitch, and
the circuitry further executes a method comprising:
evaluating the batting performance of the batter in such a manner that the batting performance is higher when the statistical batted ball velocity is higher, that the batting performance is higher when the swing-and-miss ratio is lower, and that the batting performance is higher when the statistical batted ball angle is closer to a predetermined optimal angle.

7. The performance evaluation device according to claim 5,
wherein the statistical batted ball velocity is one of a variance and a standard deviation of batted ball velocities obtained from the batting of the batter when the balls of the plurality of types of pitch are thrown at random without the batter being informed of the plurality of types of pitch,
wherein the statistical batted ball angle is one of an average value and a median value of batted ball angles obtained from the batting of the batter when the balls of the plurality of types of pitch are thrown at random without the batter being informed of the plurality of types of pitch, and
the circuitry further executes a method comprising:
evaluating the batting performance of the batter in such a manner that the batting performance is higher when the statistical batted ball velocity is lower, that the batting performance is higher when the swing-and-miss ratio is lower, and that the batting performance is higher when the statistical batted ball angle is closer to a predetermined optimal angle.

8. A data acquisition device including circuitry executing a method comprising:
acquiring data used for evaluating a batting performance of a batter in a sport in which balls pitched at various velocities are visually assessed and batted,
wherein the acquiring acquires information relevant to movements of the balls obtained as a result of batting of the batter when the balls of a plurality of types of pitch are thrown at random without the batter being informed of the plurality of types of pitch.

9. The data acquisition device according to claim 8, the circuitry further executes a method comprising:
acquiring at least a statistical batted ball velocity and a swing-and-miss ratio from the batting of the batter when the balls of the plurality of types of pitch are thrown at random without the batter being informed of the plurality of types of pitch.

10. The data acquisition device according to claim 8, the circuitry further executes a method comprising:
acquiring at least one of a statistical batted ball velocity, a swing-and-miss ratio, and a statistical batted ball angle from the batting of the batter when the balls of the plurality of types of pitch are thrown at random without the batter being informed of the plurality of types of pitch.

11. A computer-implemented method for evaluating performance, the method comprising:
evaluating a batting performance of a batter in a sport in which balls pitched at various velocities are visually assessed and batted,
wherein the evaluating is based at least on information relevant to movements of the balls obtained as a result of batting of the batter when the balls of a plurality of types of pitch are thrown at random without the batter being informed of the plurality of types of pitch.

12.-14. (canceled)

15. The computer-implemented method according to claim 11, the method further comprising:
evaluating the batting performance of the batter, based on at least a statistical batted ball velocity and a swing-and-miss ratio obtained from the batting of the batter when the balls of the plurality of types of pitch are thrown at random without the batter being informed of the plurality of types of pitch.

16. The computer-implemented method according to claim 15, the method further comprising:
evaluating the batting performance of the batter in such a manner that the batting performance is higher when the statistical batted ball velocity is higher and that the batting performance is higher when the swing-and-miss ratio is lower,
wherein the statistical batted ball velocity includes at least one of an average value, a median value, and a maximum value of batted ball velocities obtained from the batting of the batter when the balls of the plurality of types of pitch are thrown at random without the batter being informed of the plurality of types of pitch.

17. The computer-implemented method according to claim 15, the method further comprising:
evaluating the batting performance of the batter in such a manner that the batting performance is higher when the statistical batted ball velocity is lower and that the batting performance is higher when the swing-and-miss ratio is lower,
wherein the statistical batted ball velocity includes at least one of a variance and a standard deviation of batted ball velocities obtained from the batting of the batter when the balls of the plurality of types of pitch are thrown at random without the batter being informed of the plurality of types of pitch.

18. The computer-implemented method according to claim 11, the method further comprising:
evaluating the batting performance of the batter, based on at least one of a statistical batted ball velocity, a swing-and-miss ratio, and a statistical batted ball angle obtained from the batting of the batter when the balls of the plurality of types of pitch are thrown at random without the batter being informed of the plurality of types of pitch.

19. The computer-implemented method according to claim 18, the method further comprising:
evaluating the batting performance of the batter in such a manner that the batting performance is higher when the statistical batted ball velocity is higher, that the batting performance is higher when the swing-and-miss ratio is lower, and that the batting performance is higher when the statistical batted ball angle is closer to a predetermined optimal angle,
wherein the statistical batted ball velocity includes at least one of an average value, a median value, and a maximum value of batted ball velocities obtained from the batting of the batter when the balls of the plurality of types of pitch are thrown at random without the batter being informed of the plurality of types of pitch, and
wherein the statistical batted ball angle includes at least is one of the average value and a median value of batted ball angles obtained from the batting of the batter when the balls of the plurality of types of pitch are thrown at random without the batter being informed of the plurality of types of pitch.

20. The computer-implemented method according to claim 18, the method further comprising:
evaluating the batting performance of the batter in such a manner that the batting performance is higher when the statistical batted ball velocity is lower, that the batting performance is higher when the swing-and-miss ratio is lower, and that the batting performance is higher when the statistical batted ball angle is closer to a predetermined optimal angle,
wherein the statistical batted ball velocity is one of a variance and a standard deviation of batted ball velocities obtained from the batting of the batter when the balls of the plurality of types of pitch are thrown at random without the batter being informed of the plurality of types of pitch, and
wherein the statistical batted ball angle is one of an average value and a median value of batted ball angles obtained from the batting of the batter when the balls of the plurality of types of pitch are thrown at random without the batter being informed of the plurality of types of pitch.
